(19) United States
(12) Patent Application Publication
(10) Pub. No.: US 2016/0215070 A1
(43) Pub. Date: Jul. 28, 2016

(54) MICRO CHIRAL REGULATION CELLULOSE CHROMATOGRAPHY STATIONARY PHASE, PREPARATION METHOD AND USE THEREOF

(71) Applicants: The Fourth Military Medical University, Shaanxi (CN); Beijing Dima Outai Development Center of Science and Technology, Beijing (CN)

(72) Inventors: Aidong Wen, Shaanxi (CN); Guang Qing Li, Foothill Ranch, CA (US); Xiaoli Sun, Shaanxi (CN); Guohui Ma, Beijing (CN); Yanyan Jia, Shaanxi (CN)

(21) Appl. No.: 14/725,359

(22) Filed: May 29, 2015

(30) Foreign Application Priority Data
Jan. 26, 2015 (CN) 201510035871.1

(51) Int. Cl. C08B 15/06; C08B 15/04

(52) U.S. Cl. CPC C08B 15/06; C08B 15/04

(57) ABSTRACT

The present invention discloses a cellulose derivative shown as formula (I), which is obtained as follows: the hydroxyl at position 6 of microcrystalline cellulose is protected with triphenylchloromethane, and then reacted with acyl chloride or isocyanate. After the protection of the hydroxyl at positions 2 and 3 of microcrystalline cellulose, triphenylmethyl is removed under acidic conditions to expose the hydroxyl at position 6. Finally, the hydroxyl at position 6 is chiral derivatized with amino acid acyl chloride or polypeptide acyl chloride, to obtain a micro chiral regulation cellulose derivative. The micro chiral regulation cellulose derivative thus obtained is coated onto the surface of a silica gel support, to form a chiral stationary phase, which is filled in a stainless steel column to form a chiral column for the separation of various different types of chiral compounds. The preparation method of the present invention is not only efficient and convenient, but also safe and reliable. The chiral column thus formed has stable performance, high separation efficiency, and is suitable for large scale production.

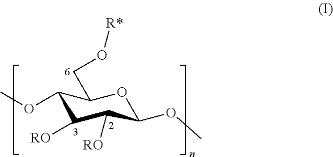

### CROSS REFERENCE TO RELATED APPLICATION

This application claims priority to Chinese Application No. 201510035871.1 filed Jan. 26, 2015. The contents of that application are incorporated herein by reference.

### FIELD OF THE INVENTION

This invention relates to a micro chiral regulation cellulose chromatography stationary phase, preparation method and use thereof in separation of chiral compounds, and belongs to the field of chiral chromatography separation.

### BACKGROUND OF THE INVENTION

High performance liquid chromatography (HPLC), being an optimal method for analysis, separation and preparation of chiral compounds, has developed rapidly in recent years. HPLC depends mainly on chiral stationary phase (CSP) for the identification and separation of chiral compounds. CSP, which is prepared from fixation of an optically active unit on the substrate, is useful for the resolution of optical isomers by differences in the reaction between the chiral environment of the stationary phase and the enantiomers.

Cellulose chiral stationary phase is a widely used polysaccharide chiral stationary phase with good resolution ability and large column volume. Cellulose has a highly organized spiral cavity structure and is therefore advantageous in chiral separations. However, due to its insolubility and non-rigidity, cellulose is not suitable for direct use as a chiral stationary phase. Derivation of hydroxyl at positions 2, 3 and 6 of cellulose with acyl chloride or isocyanate may reduce the polarity of cellulose, increase the number of chiral recognition sites, and also form a chiral cavity on the surface of a polysaccharide, and in turn improve selectivity and chiral recognition ability for enantiomers. Cellulose chiral stationary phases are already commercially available, such as OA, OB, OD and OJ (FIG. 1).

However, in the process of the derivation of cellulose for the cellulose chiral stationary phase as described above, the derivatizing agents used are all achiral agents R (FIG. 2, formula A). There is no related report on derivation of the hydroxyl at positions 2, 3 and 6 by a chiral agent (R*) and preparation of chiral stationary phase (formula B). Investigations show that a minor change in the structure of a derivatizing agent may result in great changes in the separation efficiency of the cellulose chiral stationary phase.

### SUMMARY OF THE INVENTION

The present invention provides a micro chiral regulation cellulose chromatography stationary phase, preparation method and uses thereof.

The present invention is achieved as follows:
A cellulose derivative shown as formula (I):

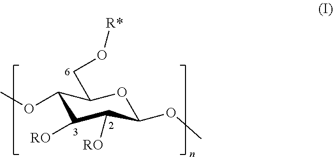

wherein, n=35˜350
R═CH₃(CH₂)ₘCO, m=0˜30
or

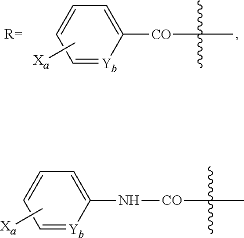

Xₐ═—CH₃, —Cl, —NO₂, a=integers of 0˜5;
Y_{b}═C, N, O, S, b=integers of 0˜5, preferably 1;
R* represents a chiral group, which is an N-protected amino acid acyl or N-protected polypeptide acyl.

A preparation method for the cellulose derivatives as described above, comprising: the hydroxyl at position 6 of cellulose is protected with triphenylchloromethane under alkaline conditions using microcrystalline cellulose as a starting material. Then, the hydroxyl at positions 2 and 3 is reacted with an acyl chloride agent (such as benzoyl chloride) or isocyanate reagent (such as 3,5-dimethylphenylisocyanate) to obtain positions 2 and 3-protected microcrystalline cellulose. Subsequently, the hydroxyl at position 6 is exposed by removing triphenylmethyl under acidic conditions. Finally, the hydroxyl at position 6 is chiral derivatized with N-protected amino acid acyl chloride or N-protected polypeptide acyl chloride, to obtain micro chiral regulation cellulose derivatives.

The acyl chloride agent is a saturated or unsaturated hydrocarbyl acyl chloride having 1 to 30 carbon atoms (such as acetyl chloride and propionyl chloride) and an aromatic cyclic acyl chloride or heteroaromatic cyclic acyl chloride having 1 to 20 carbon atoms (such as benzoyl chloride, p-methylbenzoyl chloride, 3,5-dimethyl benzoyl chloride and 2-furan formic acyl chloride).

The isocyanate agent is an aromatic cyclic isocyanate or heteroaromatic cyclic isocyanate having 1 to 20 carbon atoms (such as phenyl isocyanate, p-methylphenyl isocyanate, 3,5-dimethylphenylisocyanate and 2-furan isocyanate).

The agents for alkaline conditions as described above are selected from pyridine, triethylamine and sodium hydroxide.

The acidic agent for removing the protecting group triphenylmethyl is concentrated hydrochloric acid of 10˜37% (v/v) or sulfuric acid or FeCl₃ or ZnCl₂ Lewis acid of 10˜20% (v/v).

The N-protected amino acid acyl chloride as described above is a saturated or unsaturated amino acid acyl chloride having 1 to 30 carbon atoms (such as glycyl chloride, alanyl chloride, leucyl chloride and isoleucyl chloride) and aromatic cyclic (heteroaromatic cyclic) amino acid acyl chloride having 1 to 20 carbon atoms (such as phenylglycyl chloride, phenylalanyl chloride and prolyl chloride). The amino acid precursors used may be either natural occurring or non-natural occurring.

The N-protected polypeptide acyl chloride as described above is a polypeptide combination of various same or different amino acids. Wherein, N-terminals of all the polypeptide acyl chlorides are protected by the protecting group. The amino acid precursors used in the synthesis of a polypeptide may be natural occurring or non-natural occurring.

The application of the cellulose derivatives as described above as chiral selector in the preparation of chiral separation stationary phase comprises the following steps:

(1) disperse a dried ammoniated silica gel and the microcrystalline cellulose derivative shown by formula (I) in trichloromethane, stir for 5 to 10 hours under the protection of nitrogen, and remove the solvent under vacuum at room temperature;

(2) wash the solid with acetone, and obtain the chiral stationary phase by drying under vacuum.

The present invention has the following advantageous effects over the prior art: (1) The micro chiral regulation cellulose derivative of the present invention has wide material sources and is applicable for large scale production; (2) The micro chiral regulation cellulose derivative of the present invention as a chiral selector has a plurality of sites for hydrogen bonding interaction with analytes and may in turn produce spatial reactions due to electron donating group and chiral polypeptide chain in the cellulose; (3) The method for the synthesis of the micro chiral regulatory cellulose stationary phase is simple in steps, moderate in reaction conditions, easy to operate and has good reproducibility; (4) The stationary phase is superior in chromatography properties, with high column efficiency and loadability, favorable selectivity and resolution.

### BRIEF DESCRIPTION OF THE FIGURES

FIG. 1 shows a commercially available cellulose stationary phase;

FIG. 2 shows the derivation of cellulose;

FIG. 3 shows use of the chiral column obtained from example 14 for separation of chiral secondary alcohol 10;

FIG. 4 shows use of the chiral column obtained from example 14 for separation of chiral secondary alcohol 11;

FIG. 5 shows use of the chiral column obtained from example 15 for separation of chiral secondary alcohol 12;

FIG. 6 shows use of the chiral column obtained from example 15 for separation of chiral secondary alcohol 13;

FIG. 7 shows use of the chiral column obtained from example 16 for separation of chiral ketone 14;

FIG. 8 shows use of the chiral column obtained from example 16 for separation of chiral ketone 15;

FIG. 9 shows use of the chiral column obtained from example 17 for separation of chiral ketone 16;

FIG. 10 shows use of the chiral column obtained from example 17 for separation of chiral ketonel 7.

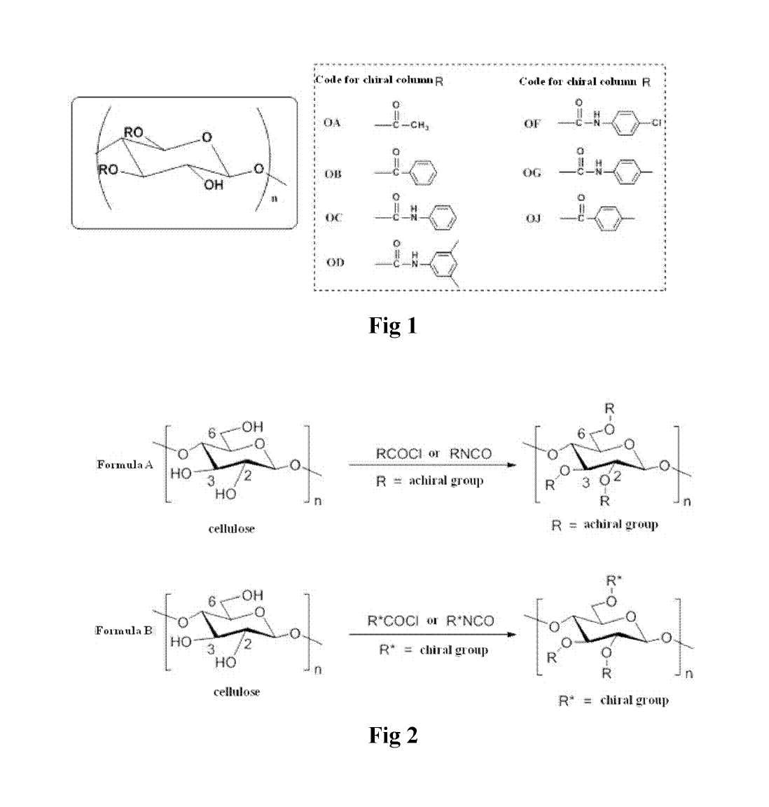

### DETAILED EMBODIMENTS

The invention will be now further illustrated in great detail in the following examples.

Synthesis of the micro chiral regulation cellulose derivatives

Step 1. Amino acid acyl halide or N-protected polypeptide acyl chloride 2 is prepared with N-protected chiral amino acid 1 or N-protected polypeptide as a starting material, taking an amino protected chiral amino acid as an example:

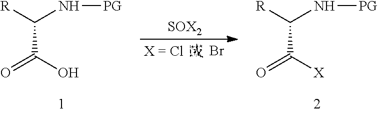

Step 2. The microcrystalline cellulose is pre-treated. First, the microcrystalline cellulose is swollen, allowing 6-hydroxy thereof to react with triphenylchloromethane (Trityl-Cl) to obtain 6-hydroxy-protected cellulose 3. Then, 3 is reacted with a derivatizing agent (comprising acetyl chloride (AcCl), aromatic acyl chloride (ArCOCl) or aromatic isocyanate (ArNCO)) under alkaline conditions, to produce 2,3-hydroxyl protected cellulose 4. Subsequently, 4 is subjected to 6-hydroxy deprotection under acidic conditions, to produce 6-hydroxyl-2,3-positions protected cellulose 5 for further use.

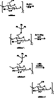

Step 3. The chiral acyl halide 2 obtained from step 1 is reacted with the cellulose derivative 5 obtained from step 2 under alkaline conditions to obtain micro chiral regulation cellulose derivatives 6-9.

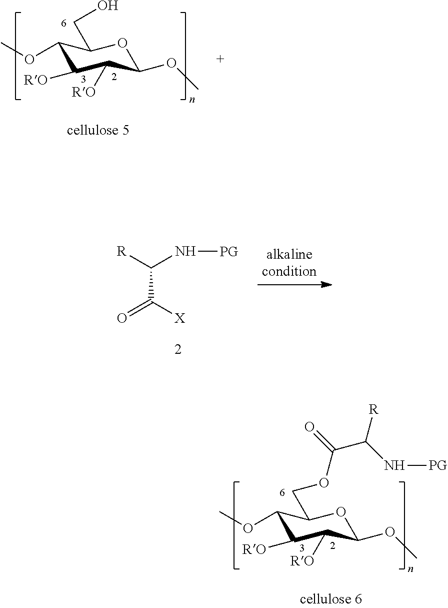

The micro chiral regulatory cellulose obtained from the synthesis steps above have the following general formula:

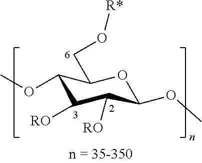

wherein, R═CH₃(CH₂)ₘCO, m=0˜30
or

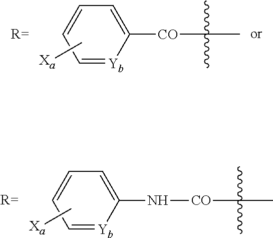

Xₐ═—CH₃, —Cl, —NO₂, a=0˜5;
Y_{b}═C, N, O, S, b=0˜5;
R* represents a chiral group
R*═N-protected amino acid acyl, or
R*═N-protected polypeptide acyl;
Protecting group=formyl, acetyl, carbobenzoxyl and fluorene methyl carbonyl.

The micro chiral regulation cellulose derivatives 6-9 are exemplified as follows:

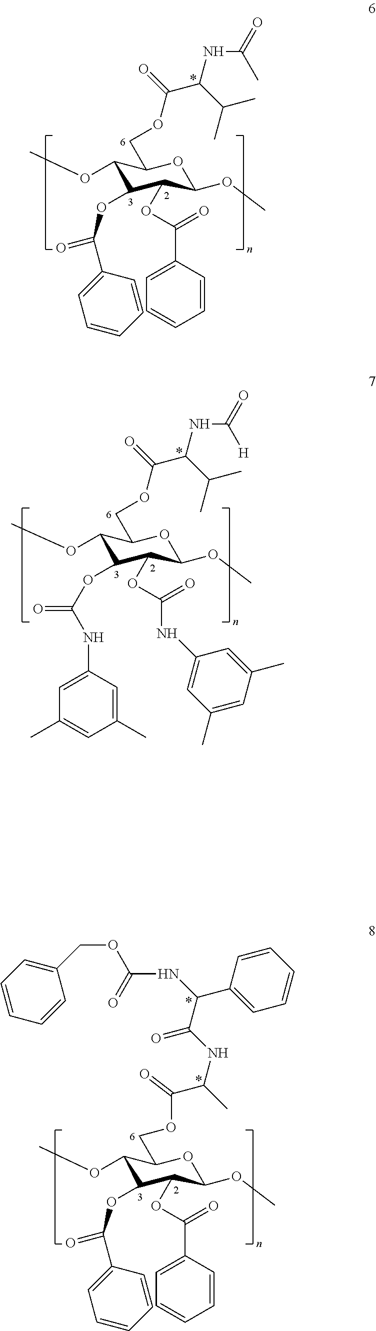

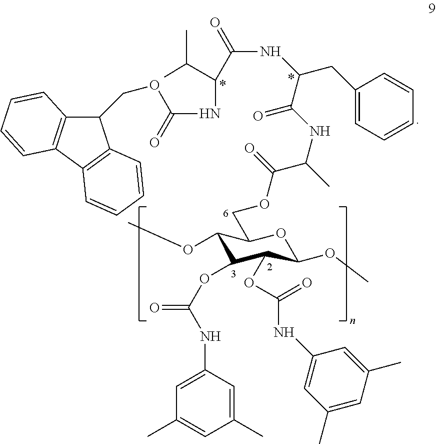

Synthesis of the micro chiral regulation cellulose stationary phase: disperse a dried ammoniated silica gel and the microcrystalline cellulose derivative as obtained above in trichloromethane, stir for 5 to 10 hours under the protection of nitrogen, remove the solvent under vacuum at room temperature; wash the solid with acetone, and obtain the chiral stationary phase by drying at 50° C. under vacuum.

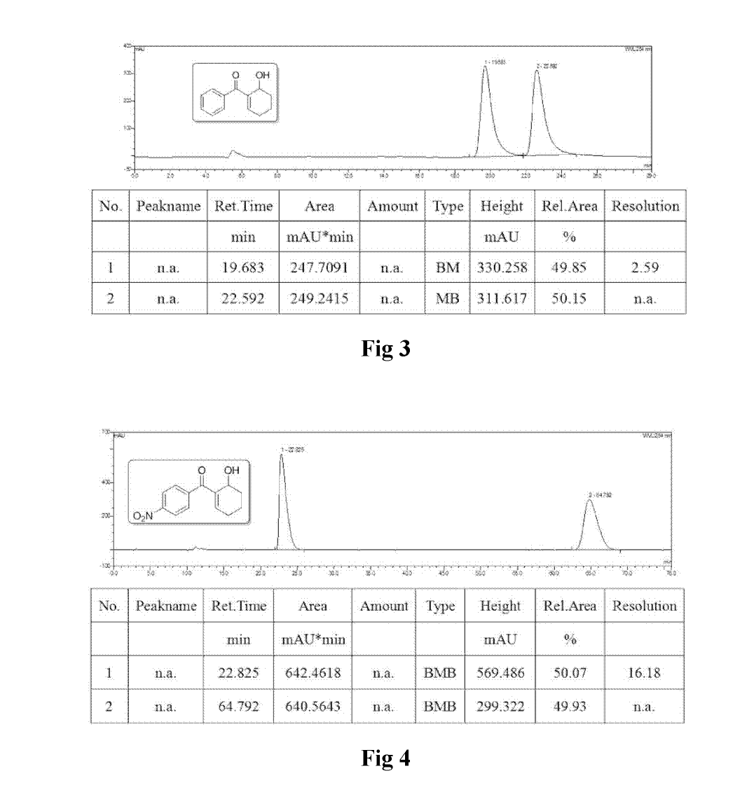

Application of the micro chiral regulation cellulose chromatography stationary phase: the micro chiral regulation cellulose derivative of the present invention as a chiral selector can be coated on the silica gel support by coating method, and is applicable for a chiral stationary phase in high performance liquid chromatography (HPLC), gas chromatography (GC), capillary electrophoresis (CE) and supercritical fluid chromatography (SFC). The prepared stationary phase has good chiral recognition ability and stable performance, and is useful for the separation of various different types of chiral compounds. For example, the micro chiral regulation cellulose stationary phase prepared as described above is filled in a stainless steel column with an inner diameter of 4.6 mm and a length of 250 mm via the slurry packing method to obtain a chiral column, which may be used for separation of various chiral compounds such as chiral secondary alcohol and chiral ketone (* represents a chiral center, see FIGS. 3-10 for separation effects).

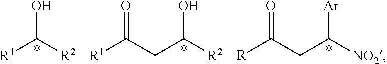

wherein R¹ is different from R².

### EXAMPLE 1

### Synthesis of 2,3-Dibenzoyl Cellulose 5a

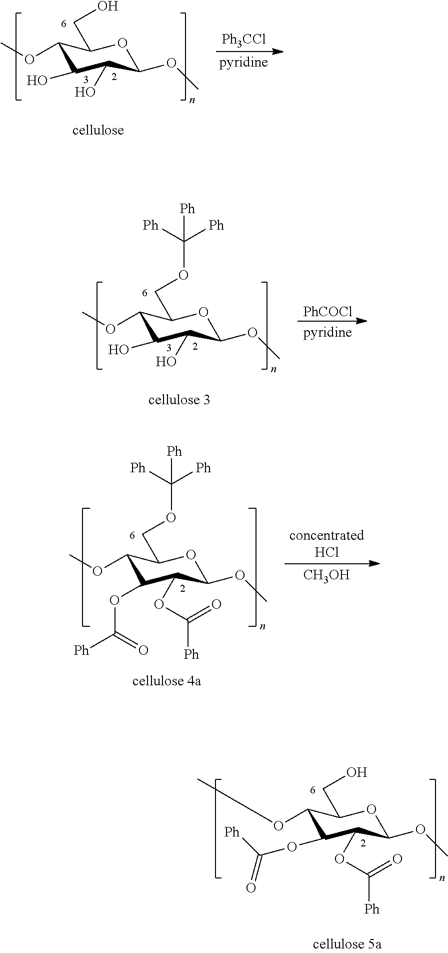

Under nitrogen atmosphere, the dried microcrystalline cellulose (6.0 g) and an excess of triphenylchloromethane (21.0 g) in 120 mL freshly distilled pyridine was heated to 90° C., stirred for 24 h and cooled to room temperature. 20.0 mL of benzoyl chloride (PhCOCl) was added carefully and heated to 90° C., stirred for 24 h, and cooled to room temperature. Solid powder was filtered, the filter cake was washed with anhydrous ethyl acetate (2×20 mL) and methanol (2×20 mL). The obtained solid was suspended in 600.0 mL methanol. 2.0 mL of concentrated HCl was added, and stirred at room temperature for 24 h. Protecting group at position 6 was removed. The reaction mixture was filtered, the filter cake was washed with methanol (10×100 mL). The solid was dried under vacuum to obtain light yellow solid powder 2,3-dibenzoyl cellulose 5a (8.2 g) which was stored in a vacuum desiccators for further use. Infrared (IR) analysis (cm⁻¹): 1765 (C═O), 1610 (Ar), 1525(Ar); Elemental analysis: C % 53.4, H % 3.51.

### EXAMPLE 2

### Synthesis of N-Cbz-L-Phenylalanyl Chloride 2a

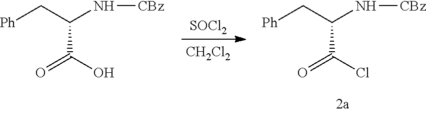

Under nitrogen atmosphere, 9.0 g of N-Cbz-L-phenylalanine was dissolved in anhydrous CH₂Cl₂ (50.0 mL), and cooled to 0° C. 15.0 mL of SOCl₂ was added slowly into the mixture over about half an hour. Then, the mixture was stirred at room temperature for 1 h, and heated to reflux for 3 hours. The redundant SOCl₂ and solvent was removed under reduced pressure to obtain brownish red slurry 2a, which is used directly for the next step without further purification.

### EXAMPLE 3

### Synthesis of the Micro Chiral Regulation Cellulose Derivative 6a

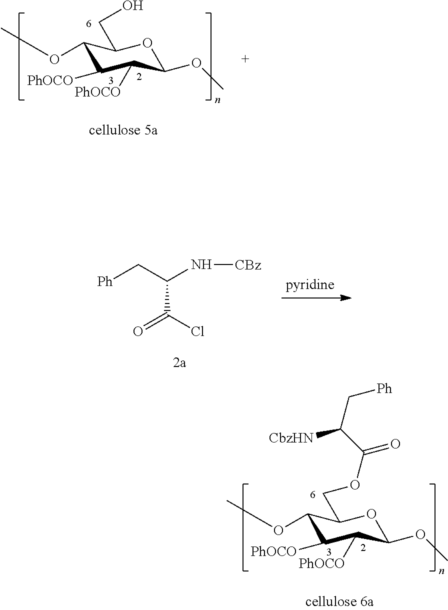

Under nitrogen atmosphere, cellulose 5a (3.6 g) was suspended in anhydrous pyridine. N-Cbz-L-phenylalanyl chloride 2a (about 10.0 g) was dissolved in anhydrous CH₂Cl₂ (20.0 mL), and added to the suspension above at room temperature. The mixture was stirred for 2 h, and then heated to 45° C. for 10 h. The solvent was removed under reduced pressure, the resultant residue was suspended in 100.0 mL of anhydrous methanol, and stirred for 2 h. The solvent was removed under reduced pressure, the resultant solid was washed with anhydrous methanol (5×100 mL), to obtain light yellow solid powder 6a. The powder was dried under vacuum for further use (4.3 g). Infrared (IR) analysis (cm⁻¹): 3150 (NH), 1760 (C═O), 1600 (Ar), 1520(Ar); Elemental analysis: C % 55.6%, N % 1.14, H % 3.72.

### EXAMPLE 4

### Synthesis of 2,3-Diphenylaminocarbonyl Cellulose 5b

Under nitrogen atmosphere, the dried microcrystalline cellulose (3.0 g) and an excess of triphenylchloromethane (10.5 g) in 60 mL freshly distilled pyridine was heated to 90° C., stirred for 24 h and cooled to room temperature. 10.0 mL of phenylisocyanate (PhNCO) was added carefully and heated to 90° C. for 24 h. The reaction mixture was filtered and washed with anhydrous ethyl acetate (2×10 mL) and methanol (2×10 mL). The obtained solid was suspended in 300 mL methanol, 1.0 mL of concentrated HCl was added, and stirred at room temperature for 24 h. Protecting group at position 6 was removed. The reaction mixture was filtered and washed with methanol (10×50 mL). The resultant solid was dried under vacuum to obtain light yellow solid powder 2,3-phenylaminocarbonyl cellulose 5b (5.1 g) which was stored in a vacuum desiccators for further use. Infrared (IR) analysis (cm⁻¹): 3340 (NH), 1750 (C═O), 1590 (Ar), 1510(Ar); Elemental analysis:
C % 52.3, N % 4.84, H % 3.64.

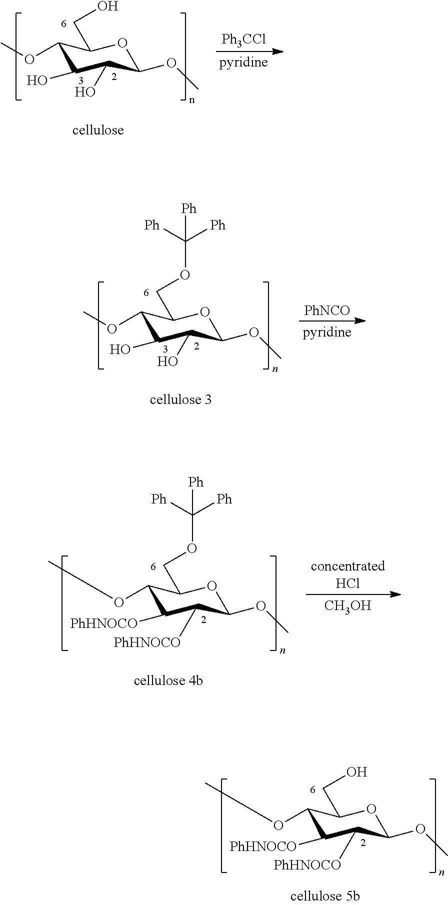

### EXAMPLE 5

### Synthesis of N-Fmoc-L-Phenylalanyl Chloride 2b

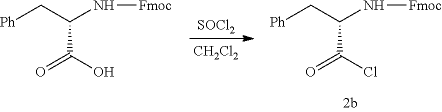

Under nitrogen atmosphere, 7.8 g of N-Fmoc-L-phenylalanine was dissolved in anhydrous CH₂Cl₂ (40.0 mL), and cooled to 0° C. 10.0 mL of SOCl₂ was added slowly into the mixture over about half an hour. The mixture was stirred at room temperature for 1 h, and heated to reflux for 3 hours. The redundant SOCl₂ and solvent was removed under reduced pressure to obtain brownish red slurry 2b, which is used directly for the next step without further purification.

### EXAMPLE 6

### Synthesis of the Micro Chiral Regulation Cellulose Derivatives 7a

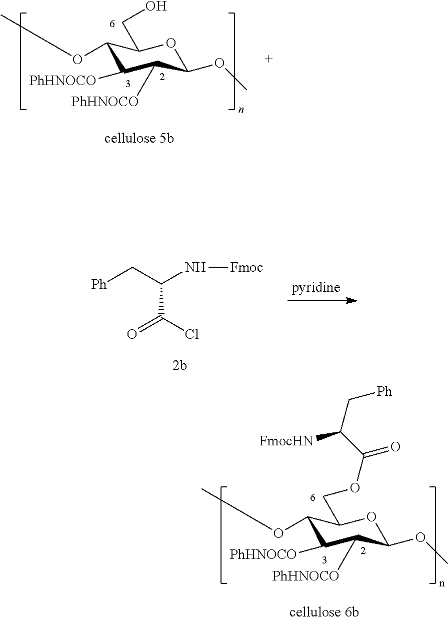

Under nitrogen atmosphere, cellulose 5b (3.0 g) was suspended in anhydrous pyridine. N-Fmoc-L-phenylalanyl chloride 2b (about 12.0 g) was dissolved in anhydrous CH₂Cl₂ (20.0 mL), and added to the suspension above at room temperature. The mixture was stirred for 2 h, and then heated to 45° C. for 10 h. The solvent was removed under reduced pressure, the resultant residue was suspended in 150.0 mL of anhydrous methanol, and stirred for 2 h. The solvent was removed under reduced pressure, the resultant solid was washed with anhydrous methanol (5×120 mL) to obtain light yellow solid powder 6b which was dried for further use (5.4 g). Infrared (IR) analysis (cm⁻¹):
3190 (NH), 1740 (C═O), 1620 (Ar), 1510 (Ar); Elemental analysis:
C % 57.6, N % 6.34, H % 4,28.

### EXAMPLE 7

### Synthesis of 2,3-Di(3,5-Dimethyl) Benzoyl Cellulose 5c

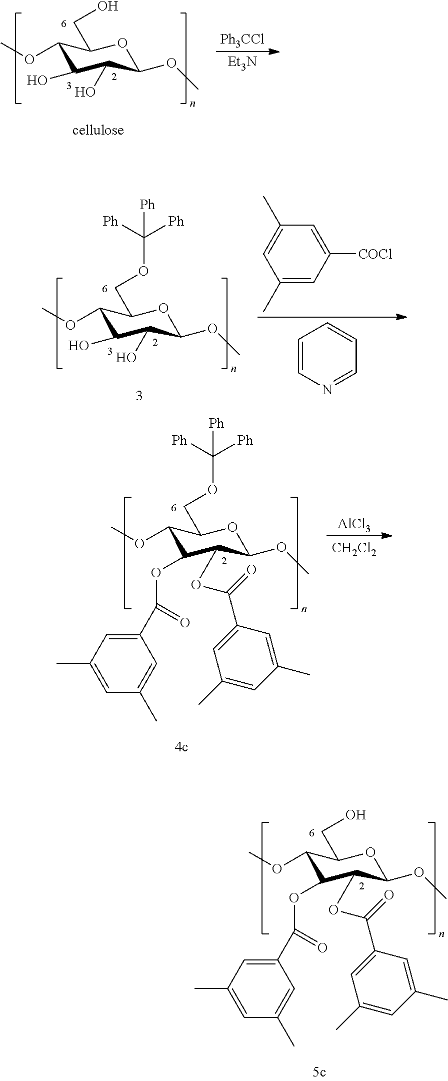

Under nitrogen atmosphere, the dried microcrystalline cellulose (3.0 g) and an excess of triphenylchloromethane (10.5 g) in 60 mL freshly distilled triethylamine was refluxed for 24 h and then cooled to room temperature. 60.0 mL of freshly distilled pyridine was added, and then 20.0 mL of 3,5-dimethylbenzoyl chloride was added carefully and heated to 90° C. for 24 h. The reaction mixture was filtered and washed with anhydrous ethyl acetate (2×20 mL) and methanol (2×20 mL). The obtained solid was suspended in 400.0 mL dichloromethane. 2.0 g of anhydrous AlCl₃ was added, and stirred at room temperature for 24 h. Protecting group at position 6 was removed. The reaction mixture was filtered and washed with methanol (10×50.0 mL). The resultant solid was dried under vacuum to obtain light yellow solid powder 2,3-di(3,5-dimethyl) benzoyl cellulose 5c (4.1 g) which was stored in a vacuum desiccators for further use. Infrared (IR) analysis (cm⁻¹):
1750 (C═O), 1590 (Ar), 1510(Ar); Elemental analysis: C % 58.2, H % 4.79.

### EXAMPLE 8

### Synthesis of N-Cbz-L-Phenylalanyl-L-Alanyl Chloride 2c

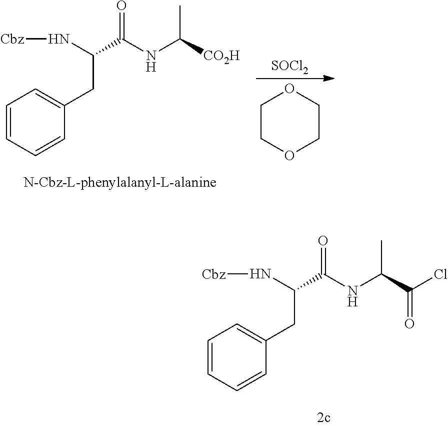

Under nitrogen atmosphere, 7.4 g of N-Cbz-L-phenylalanyl-L-alanine was dissolved in anhydrous 1,4-dioxane (50.0 mL), and cooled to 0° C. 10.0 mL of SOCl₂ was added slowly into the mixture over about half an hour. The mixture was stirred at room temperature for 1 h, and heated to reflux for 3 hours. The redundant SOCl₂ and solvent was removed under reduced pressure to obtain brownish slurry 2c, which is used directly for the next step without further purification.

### EXAMPLE 9

### Synthesis of the Micro Chiral Regulation Cellulose Derivative 8a

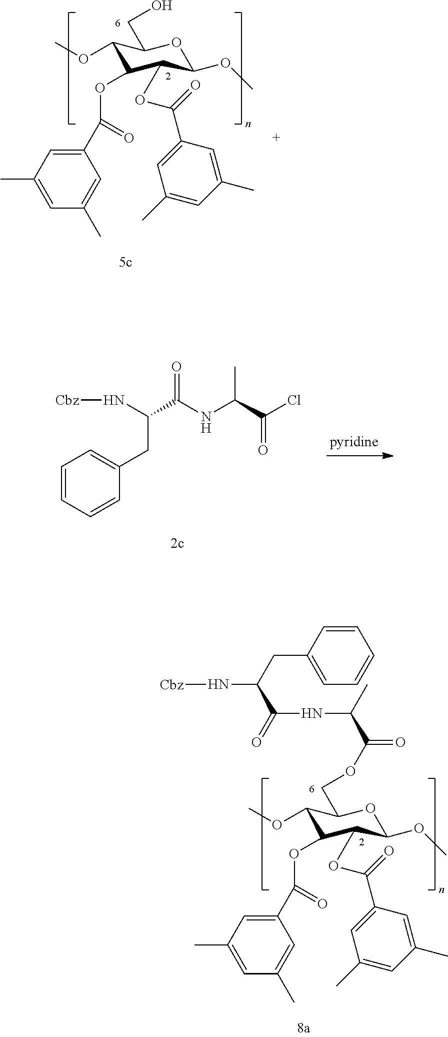

Under nitrogen atmosphere, cellulose 5c (3.0 g) was suspended in an anhydrous pyridine. N-Cbz-L-phenylalanyl-L-alanyl chloride 2c (about 8.0 g) was dissolved in anhydrous CH₂Cl₂ (20.0 mL). The mixture was added to the suspension above at room temperature and stirred for 2 h, and then heated to 45° C. and for 10 h. The solvent was removed under reduced pressure, the resultant residues was suspended in 100.0 mL of anhydrous methanol, and stirred for 2 h. The solvent was removed under reduced pressure, the resultant solid was washed with anhydrous methanol (5×100 mL) to obtain light yellow solid powder 8a (4.5 g), which was dried under vacuum for further use. Infrared (IR) analysis (cm⁻¹): 3190 (NH), 1680 (C═O), 1595 (Ar), 1515(Ar); Elemental analysis:
C % 54.2, N % 2,48, H % 4.39.

### EXAMPLE 10

### Synthesis of 2,3-Di(4-Methyl)Phenylaminocarbonyl Cellulose 5d

Under nitrogen atmosphere, the dried microcrystalline cellulose (6.0 g) and an excess of triphenylchloromethane (21.0 g) in 60 mL freshly distilled pyridine was heated to 90° C., stirred for 24 h and cooled to room temperature. 10.0 mL of 4-methylisocyanate was added carefully and heated to 90° C. for 24 h. The reaction mixture was filtered and washed with anhydrous ethyl acetate (2×10 mL) and methanol (2×10 mL). The obtained solid was suspended in 300.0 mL methanol, 1.0 mL of concentrated HCl was added, and stirred at room temperature for 24 h. The reaction mixture was filtered and washed with methanol (10×50 mL). The resultant solid was dried under vacuum to obtain light yellow solid powder 2,3-di(4-methyl)phenylaminocarbonyl cellulose 5d (8.3 g) which was stored in a vacuum desiccators for further use. Infrared (IR) analysis (cm⁻¹): 3315(NH), 1770 (C═O), 1610 (Ar), 1540(Ar), 845(Ar); Elemental analysis: C % 52.8, N % 4.21%, H % 4.35.

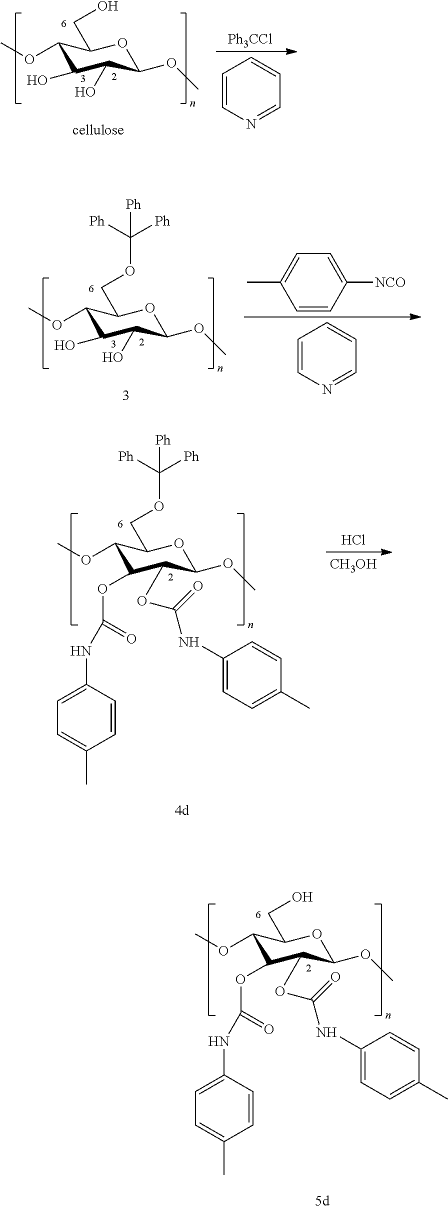

### EXAMPLE 11

### Synthesis of N-Fmoc-L-Phenylalanyl-L-Alanyl-L-Valyl Chloride 2d

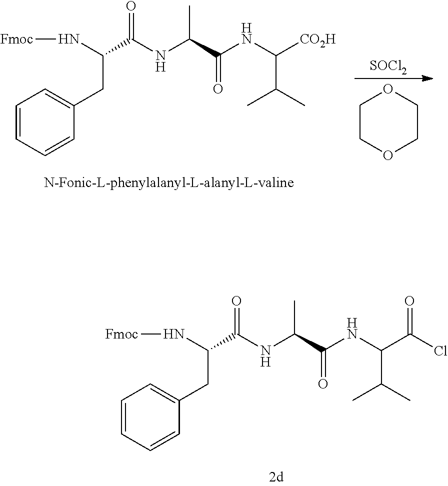

Under nitrogen atmosphere, 10.9 g of N-Fomc-L-phenylalanyl-L-alanyl-L-valine was dissolved in anhydrous 1,4-dioxane (100.0 mL), and cooled to 0° C. 20.0 mL of SOCl₂ was added slowly into the mixture over about half an hour. The mixture was stirred at room temperature for 1 h, and heated to reflux for 3 hours. The redundant SOCl₂ and solvent was removed under reduced pressure to obtain brownish black solid 2d, which is used directly for the next step without further purification.

### EXAMPLE 12

### Synthesis of Micro Chiral Regulation Cellulose Derivative 9a

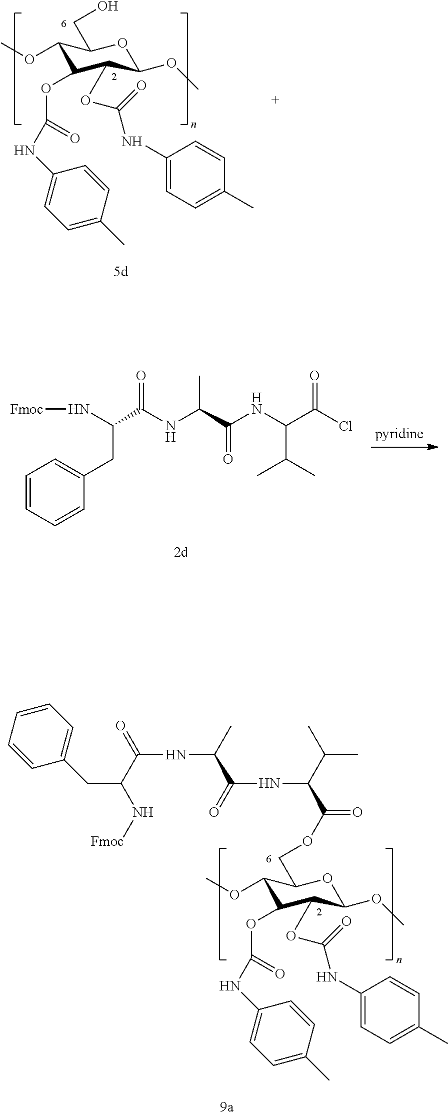

Under nitrogen atmosphere, cellulose 5d (3.0 g) was suspended in an anhydrous pyridine. N-Fmoc-L-phenylalanyl-L-alanyle-L-valyl chloride 2d (about 10.0 g) was dissolved in anhydrous CH₂Cl₂ (20.0 mL). The mixture was added to the suspension above at room temperature, and stirred for 2 h, and then heated to 45° C. for 10 h. The solvent was removed under reduced pressure, the resultant residue was suspended in 150.0 mL of anhydrous methanol, and stirred for 2 h. The solvent was removed under reduced pressure, the resultant solid was washed with anhydrous methanol (5×120 mL) to obtain light yellow solid powder 9a, which was dried under vacuum for further use (6.5 g). Infrared (IR) analysis (cm⁻¹): 3310 (NH), 1780 (C═O), 1600 (Ar), 1525(Ar); Elemental analysis:
C % 45.9, N % 8.12%, H % 4.89.

### EXAMPLE 13

5.0 g of dried ammoniated silica gel and microcrystalline cellulose derivatives 6a, 7a, 8a and 9a obtained by equimolar synthesis were weighed out, and added to 30 mL of trichloromethane respectively. The reaction mixture was stirred under nitrogen atmosphere for 5˜10 h. The solvent was removed under vacuum at room temperature, the solid was washed with acetone, and dried at 50° C. under vacuum for 24 h, to obtain chiral stationary phases 6a-solid, 7a-solid, 8a-solid and 9a-solid, respectively.

### EXAMPLE 14

3 g of chiral stationary phase 6a-solid obtained from example 13 was weighed out, and filled in a stainless steel column with a dimension of 250×4.6 mm ID via the slurry packing method. The resultant chiral column was used for separation of a chiral sample. Agilent 1200 LC was used to detect the column above at a suitable flow rate, with chiral secondary alcohols 10 and 11 as the tested samples, and n-hexane and i-PrOH as the mobile phase, and a detection wavelength of 254 nm. The separation condition for chiral secondary alcohol 10 was as follows: the chiral column obtained from example 14, a column pressure of 35 MPa, a mobile phase of n-hexane and i-PrOH in a ratio of 95:5 (v/v), a flow rate of 0.8 mL/min, the chromatogram obtained is shown in FIG. 3. The separation condition for chiral secondary alcohol 11 was as follows: the chiral column obtained from example 14, a column pressure of 40 MPa, a mobile phase of n-hexane and i-PrOH in a ratio of 90:10 (v/v), a flow rate of 1.0 mL/min, the chromatogram obtained is shown in FIG. 4.

### EXAMPLE 15

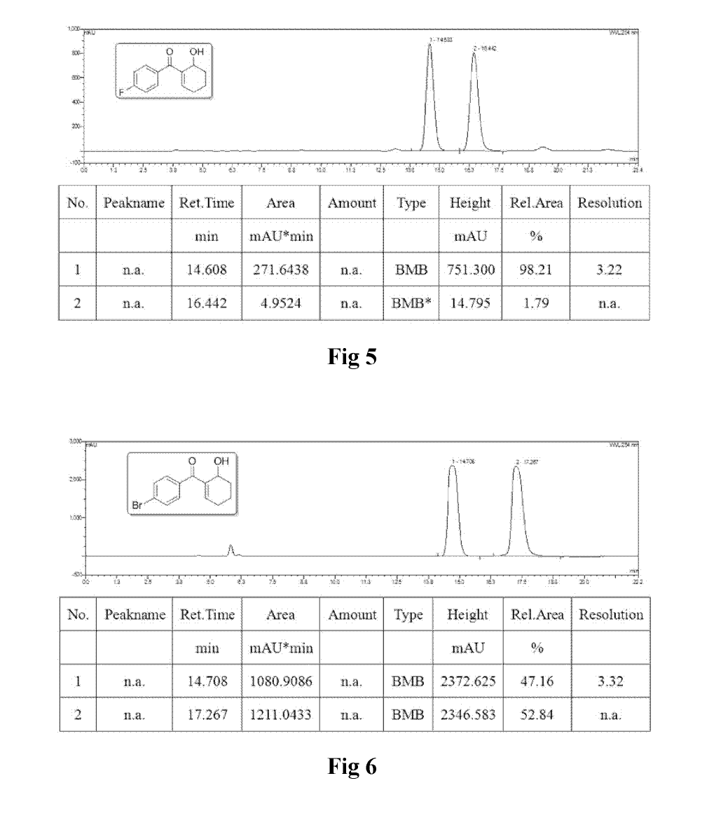

3 g of chiral stationary phase 7a-solid obtained from example 13 was weighed out, and filled in a stainless steel column with a dimension of 250×4.6 mm ID via the slurry packing method. The resultant chiral column was used for the separation of a chiral sample. Agilent 1200 LC was used to detect the column above at a suitable flow rate, with chiral secondary alcohols 12 and 13 as the tested samples, and n-hexane and i-PrOH as the mobile phase, and a detection wavelength of 254 nm. The separation condition for chiral secondary alcohol 12 was as follows: the chiral column obtained from example 16, a column pressure of 38 MPa, a mobile phase of n-hexane and i-PrOH in a ratio of 90:10 (v/v), a flow rate of 0.8 mL/min, the chromatogram obtained is shown in FIG. 5. The separation condition for chiral secondary alcohol 13 was as follows: the chiral column obtained from example 16, a column pressure of 45 MPa, a mobile phase of n-hexane and i-PrOH in a ratio of 90:10 (v/v), a flow rate of 1.0 mL/min, the chromatogram obtained is shown in FIG. 6.

### EXAMPLE 16

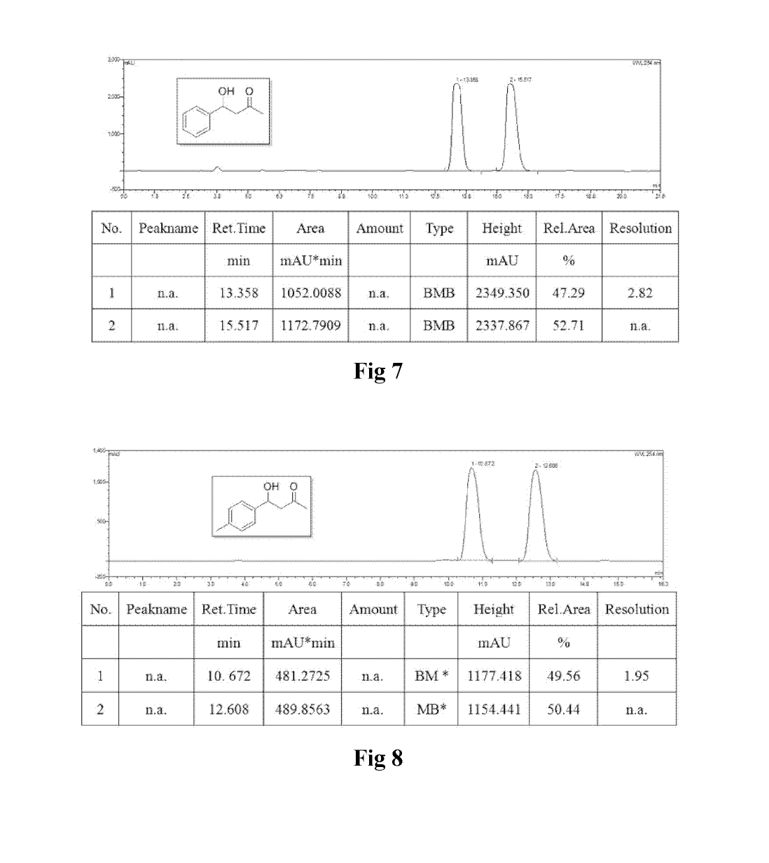

3 g of chiral stationary phase 8a-solid obtained from example 13 was weighed out, and filled in a stainless steel column with a dimension of 250×4 6 mm ID via the slurry packing method. The resultant chiral column was used for the separation of a chiral sample. Agilent 1200 LC was used to detect the column above at a suitable flow rate, with chiral ketones 14 and 15 as the tested samples, and n-hexane and i-PrOH as the mobile phase, and a detection wavelength of 254 nm. The separation condition for chiral ketone 14 was as follows: the chiral column obtained from example 18, a column pressure of 35 MPa, a mobile phase of n-hexane and i-PrOH in a ratio of 90:10 (v/v), a flow rate of 1.0 mL/min, the chromatogram obtained is shown in FIG. 7. The separation condition for chiral ketone 15 was as follows: the chiral column obtained from example 18, a column pressure of 40 MPa, a mobile phase of n-hexane and i-PrOH in a ratio of 90:10 (v/v), a flow rate of 1.0 mL/min, the chromatogram obtained is shown in FIG. 8.

### EXAMPLE 17

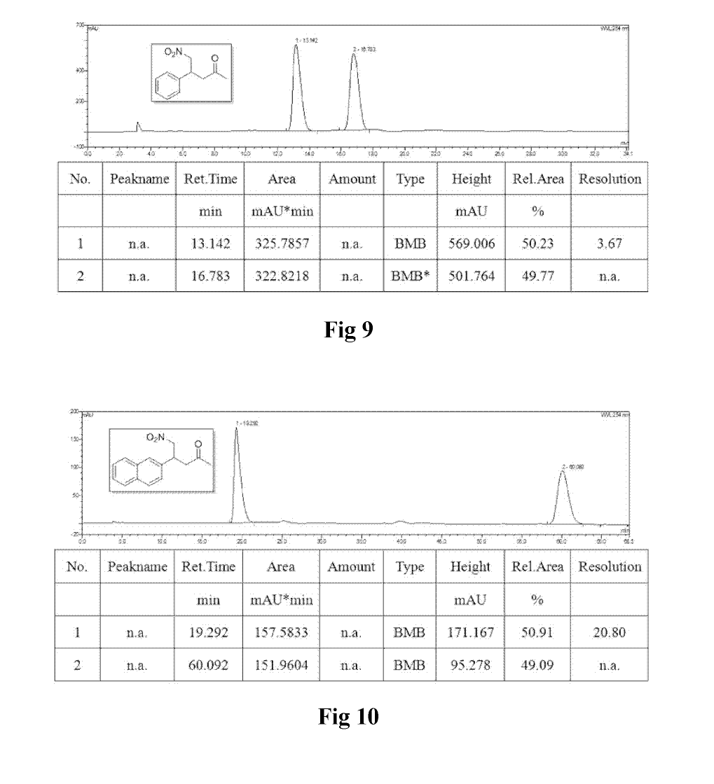

3 g of chiral stationary phase 9a-solid obtained from example 13 was weighed out, and filled in a stainless steel column with a dimension of 250×4 6 mm ID via the slurry packing method. The resultant chiral column was used for the separation of a chiral sample. Agilent 1200 LC was used to detect the column above at a suitable flow rate, with chiral ketones 16 and 17 as the tested samples, and n-hexane and i-PrOH as the mobile phase, and a detection wavelength of 254 nm. The separation condition for chiral ketone 16 was as follows: the chiral column obtained from example 20, a column pressure of 40 MPa, a mobile phase of n-hexane and i-PrOH in a ratio of 85:15 (v/v), a flow rate of 1.0 mL/min, the chromatogram obtained is shown in FIG. 9. The separation condition for chiral ketone 17 was as follows: the chiral column obtained from example 20, a column pressure of 45 MPa, a mobile phase of n-hexane and i-PrOH in a ratio of 90:10 (v/v), a flow rate of 0.7 mL/min, the chromatogram obtained is shown in FIG. 10.

1. A cellulose derivative shown as formula (I): 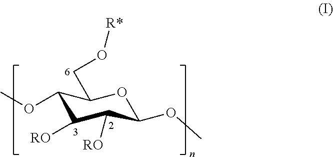
wherein, n=35˜350,
R═CH₃(CH₂)ₘCO, m=0˜30,
or 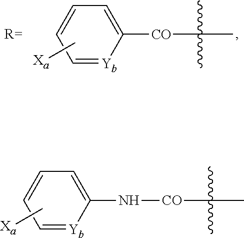
Xₐ═—CH₃, —Cl, —NO₂, a=0˜5;
Y_{b}═C, N, O, S, b=0˜5;
R* represents a chiral group, which is an N-protected amino acid acyl or N-protected polypeptide acyl.

2. A preparation method for the cellulose derivative according to claim 1, which is characterized by comprising the following steps: the hydroxyl at position 6 of cellulose is protected with triphenylchloromethane under alkaline conditions using microcrystalline cellulose as starting material; then, the hydroxyl at positions 2 and 3 is reacted with an acyl chloride agent or isocyanate reagent under alkaline conditions to obtain hydroxyl at positions 2 and 3-protected microcrystalline cellulose; subsequently, the hydroxyl at position 6 is exposed by removing triphenylmethyl under acidic conditions; finally, the hydroxyl at position 6 is chiral derivatized with N-protected amino acid acyl chloride or N-protected polypeptide acyl chloride, to obtain micro chiral regulation cellulose derivatives.

3. The preparation method for the cellulose derivative according to claim 2, wherein the acyl chloride agent is a saturated or unsaturated hydrocarbyl acyl chloride having 1 to 30 carbon atoms and an aromatic cyclic acyl chloride or heteroaromatic cyclic acyl chloride having 1 to 20 carbon atoms.

4. The preparation method for the cellulose derivative according to claim 2, wherein the isocyanate agent is an aromatic cyclic isocyanate or heteroaromatic cyclic isocyanate having 1 to 20 carbon atoms.

5. The preparation method for the cellulose derivative according to claim 2, wherein the agents for alkaline conditions are selected from pyridine, triethylamine and sodium hydroxide.

6. The preparation method for the cellulose derivative according to claim 2, wherein the acidic agent for removing the protecting group triphenylmethyl is concentrated hydrochloric acid of 10˜37% (v/v) or sulfuric acid or FeCl₃ or ZnCl₂ Lewis acid of 10˜20% (v/v).

7. The preparation method for the cellulose derivative according to claim 2, wherein the N-protected amino acid acyl chloride is a saturated or unsaturated amino acid acyl chloride having 1 to 30 carbon atoms and an aromatic or heteroaromatic cyclic amino acid acyl chloride having 1 to 20 carbon atoms; and the amino acid precursors used may be either natural occurring or non-natural occurring.

8. The preparation method for the cellulose derivative according to claim 2, wherein the N-protected polypeptide acyl chloride is a polypeptide combination of various same or different amino acids; wherein, N-terminals of all the polypeptide acyl chlorides are protected by a protecting group, and the amino acid precursors used in the synthesis of a polypeptide may be natural occurring or non-natural occurring.

9. Use of the cellulose derivatives according to claim 1 as chiral selector in the preparation of a chiral stationary phase.

10. The use according to claim 9, which is characterized by comprising the following steps:
(1) disperse a dried ammoniated silica gel and the microcrystalline cellulose derivative shown as formula (I) in trichloromethane, stir for 5 to 10 hours under the protection of nitrogen, and then remove the solvent under vacuum at room temperature;
(2) wash the solid with acetone, and obtain a chiral stationary phase by drying under vacuum.
